(19) United States
(12) Patent Application Publication
(10) Pub. No.: US 2025/0237923 A1
(43) Pub. Date: Jul. 24, 2025

(54) COLOR-EXHIBITING STRUCTURE FOR HIDING RADAR SENSOR, AND A RADAR APPARATUS

(71) Applicant: UNIVERSITY-INDUSTRY COOPERATION GROUP OF KYUNG HEE UNIVERSITY, Yongin-si (KR)

(72) Inventors: Sun Kyung KIM, Suwon-si (KR); Eun Joo LEE, Goyang-si (KR); Jun Young KIM, Yongin-si (KR)

(73) Assignee: UNIVERSITY-INDUSTRY COOPERATION GROUP OF KYUNG HEE UNIVERSITY, Yongin-si (KR)

(21) Appl. No.: 19/018,328

(22) Filed: Jan. 13, 2025

(30) Foreign Application Priority Data
Jan. 24, 2024 (KR) 10-2024-0010762

(51) Int. Cl. G02F 1/21; G01S 7/02; G01S 13/04; G02F 1/00

(52) U.S. Cl. CPC G02F 1/21; G01S 7/027; G01S 13/04; G02F 1/0063; G02F 2201/08; G02F 2201/34; G02F 2201/40; G02F 2201/50; G02F 2203/055; G02F 2203/58

(57) ABSTRACT

The present disclosure provides a color-exhibiting structure, which is a metamaterial structure including a metal pattern layer in which metal patterns having a unit metamaterial pattern formed to satisfying a relationship of T>(1−E) when a transmittance (T) of microwaves is a metal filling fraction (E) in a specific frequency band of the microwaves are periodically arranged; and a color implementation pattern layer having the same unit metamaterial pattern as the metal pattern and laminated with one or more dielectric layers or metal layers on top of the metal pattern layer.

### CROSS-REFERENCE TO RELATED APPLICATION

This application claims priority to Korean Patent Application No. 10-2024-0010762, filed on Jan. 24, 2024, in the Korean Intellectual Property Office, the disclosure of which is incorporated herein by reference.

### BACKGROUND OF THE DISCLOSURE

### Field of the Disclosure

The present disclosure relates to a color-type transparent heater, and more particularly, to a color-exhibiting structure for hiding sensors such as radar sensors or lidar sensors in autonomous mobility or mobile communication terminals with ISAC (Integrated Sensing and Communication), and a radar apparatus.

This work was supported by the National Research Foundation of Korea through the Nano Material Technology Development Program (2022M3H4A1A02046445).

### Description of the Related Art

As the hyper-connected society arrives, smart mobility platforms such as self-driving cars and drones are expected to play a key role. These platforms rely heavily on radar sensors or autonomous driving sensors (hereinafter collectively referred to as “radar sensors”) operating in the microwave frequency range (70 to 110 GHz) or mobile communication equipment operating in the 5G band (4.4 to 52.6 GHz). To ensure that these radar sensors and mobile communication equipment maintain sufficient performance levels under harsh conditions, the introduction of heaters with thermal control functions is necessary.

The heaters of the prior art are made of metal. These heaters have a conspicuous appearance that does not match the design of the vehicle or mobile communication terminal, and are therefore aesthetically unsatisfactory. Therefore, a technology is required that complements the aesthetic aspect while meeting the functional requirements.

A transparent heater material that satisfies the aesthetic aspect must be able to “transmit” specific or broad frequencies in the 4.4 to 52.6 GHz band or 70 to 110 GHz band while acting as a reflector or absorber for specific wavelength ranges in the visible light range.

Conventional color-implementing microwave transparent heaters for radar sensors require the introduction of multi-wavelength design techniques to meet functional and aesthetic requirements.

Microwave transparent heaters for radar sensors must have high conductivity (or low sheet resistance) to improve operating temperature and temperature uniformity while minimizing the attenuation of the microwaves used for communication.

In addition, high durability and high elasticity characteristics may be required for reliability under harsh conditions and attachment of curved sensor covers.

Transmittance and electrical conductivity, which are the main performance indicators of transparent heaters, are generally in a trade-off relationship.

When using a general grid-type metal transparent electrode, the electrical conductivity and heat generation performance are improved in proportion to the metal filling fraction, but the microwave transmittance decreases, thereby degrading the quality of the communication signal. Achieving both high transmittance and high conductivity simultaneously has been a long-standing challenge in transparent heaters for radar sensors.

In addition, in mobile communication terminals such as 5G/6G mobile communication terminals, a color-exhibiting structure that implements color for aesthetic purposes and allows microwaves to be transmitted is required.

### RELATED ART DOCUMENTS

### Patent Documents

(Patent Document 1) Korean Patent No. 10-2133080, “MULTILAYER FILM STRUCTURE FOR HEAT RADIATOR, HEAT RADIATOR, AND METHOD FOR MANUFACTURING THE SAME”

### SUMMARY OF THE DISCLOSURE

Therefore, the present disclosure has been made in view of the above problems, and it is an object of the present disclosure to provide a color-exhibiting structure for hiding a radar sensor of autonomous mobility or a mobile communication terminal that is capable of achieving high transmittance and high conductivity simultaneously, and a radar apparatus.

It is another object of the present disclosure to provide a color-exhibiting structure for hiding a radar sensor of autonomous mobility or a mobile communication terminal, which is a microwave transparent heater that combines functionality and aesthetic elements and maintains communication functions without affecting the exterior design of a vehicle, and a radar apparatus.

In accordance with one aspect of the present disclosure, provided is a color-exhibiting structure, wherein the color-exhibiting structure is a metamaterial structure including a metal pattern layer in which metal patterns having a unit metamaterial pattern formed to satisfy a relationship of T>(1−E) when a transmittance (T) of microwaves is a metal filling fraction (E) in a specific frequency band of the microwaves are periodically arranged; and a color implementation pattern layer having the same unit metamaterial pattern as the metal pattern and laminated with one or more dielectric layers or metal layers on top of the metal pattern layer.

The color implementation pattern layer may be formed as a single thin film layer laminated with a non-light-absorbing single dielectric thin film whose thickness is set to implement a structure color by interference between incident visible light and visible light reflected from the metal pattern layer.

The color implementation pattern layer may be formed as a single thin film layer laminated with a light-absorbing single dielectric thin film whose thickness is set to implement a structure color by interference between incident visible light and visible light reflected from the metal pattern layer.

The color implementation pattern layer may include a non-light-absorbing single dielectric thin film whose thickness is set to implement a structure color by interference between incident visible light and visible light reflected from the metal pattern layer; and a light-absorbing single dielectric thin film whose thickness is set to implement a structure color by interference between incident visible light and visible light reflected from the metal pattern layer, and may formed as a multilayer thin-film layer formed by alternately laminating the non-light-absorbing dielectric thin film and the light-absorbing dielectric thin film one or more times.

The color implementation pattern layer may be formed as a multilayer thin-film layer including a non-light-absorbing dielectric thin-film layer whose thickness is set to implement a structure color by interference between incident visible light and visible light reflected from the metal pattern layer; and a metal layer whose thickness is set to implement a structure color by interference between incident visible light and visible light reflected from the metal pattern layer, wherein the thin-film layer and the metal layer are alternately laminated one or more times.

The color implementation pattern layer may be designed to have a thickness of λ/4 when a wavelength of the structure color to be implemented is A.

The color implementation pattern layer may be formed as a multilayer thin-film layer including a light-absorbing dielectric thin-film layer whose thickness is set to implement a structure color by interference between incident visible light and visible light reflected from the metal pattern layer; and a metal layer whose thickness is set to implement a structure color by interference between incident visible light and visible light reflected from the metal pattern layer, wherein the thin-film layer and the metal layer are alternately laminated one or more times.

The color implementation pattern layer may be designed to have a thickness of λ/4 or less when a wavelength of the structure color to be implemented is λ.

The unit metamaterial pattern may have structural symmetry with respect to two mutually orthogonal directions with respect to a center point of a unit area of the metal pattern so that the polarization dependence on microwaves does not occur.

The unit metamaterial pattern may include a first linear pattern formed long in a first direction in a unit area of the unit metamaterial pattern; a second linear pattern formed long in a second direction in the unit area of the unit metamaterial pattern so as to intersect with the first linear pattern; and an external pattern electrically interconnected to the first linear pattern and the second linear pattern from an outside of the first linear pattern and the second linear pattern, and arranged radially, centered on an intersection of the first linear pattern and the second linear pattern.

The external pattern may further include a pattern gap formed by opening a portion of the external pattern to perform an electric dipole function.

When a unit area of the metal pattern is divided into quadrant areas, at least one pattern gap may be placed in each of the quadrant areas.

In the color-exhibiting structure, the specific frequency band of the microwaves may be varied by selectively changing structural parameters of the unit metamaterial structure, and the structural parameters may include one or more of size, length, thickness, width, and separation distance of each component having a structural symmetry of a unit metamaterial pattern constituting the unit metamaterial structure.

The specific frequency band of the microwaves may be set to 70 to 110 GHz including a W band or 4.4 to 52.6 GHz, which is a 5G/6G communication frequency band, and the transmittance of microwaves may be determined to satisfy a relationship of T>(1−E) regardless of a size of the metal filling fraction in the specific frequency band of the microwaves.

The metal pattern layer may be formed such that a relationship between a metal filling fraction (E) per unit area of the metal pattern and a transmittance (T) of the microwaves satisfies a relationship of T>(1−E) for both orthogonal polarizations in the specific frequency band of the microwaves.

A metal forming the metal pattern layer may include one or more of copper, silver, gold, aluminum, a liquid metal, and an alloy including any one of copper, silver, gold, and aluminum.

The color-exhibiting structure may have a pattern structure in which a plurality of unit metamaterial structures are sequentially connected, wherein the unit metamaterial structures include laminated unit metal pattern layers having the unit metamaterial pattern and a unit color implementation pattern layer laminated on top of the unit metal pattern layers.

The unit metal pattern layers may be electrically interconnected with each other, and the color-exhibiting structure may be applied as a transparent heater for shielding a radar sensor or lidar sensor by further including an electric terminal having one end that is connected to the metal pattern layer and the other end to which external electricity is applied for heating the metal pattern layer.

The unit metal pattern layers may be arranged to be electrically open to each other, and the color-exhibiting structure may be applied as a color implementation structure for shielding a radar sensor or lidar sensor of a mobile communication terminal.

In accordance with another aspect of the present disclosure, provided is a radar apparatus including the color-exhibiting structure of a metamaterial structure; a protective cover made of transparent material placed on a front of the color-exhibiting structure to protect the color-exhibiting structure; and a radar sensor module positioned at a rear of the color-exhibiting structure to detect obstacles in front of the protective cover through microwaves passing through the protective cover and the color-exhibiting structure.

The radar apparatus may further include an insulating packaging member made of transparent material placed between the color-exhibiting structure and the protective cover; and a substrate member made of transparent material placed between the color-exhibiting structure and the radar sensor module.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a diagram showing the relationship between transmittance (T) and metal filling fraction (E) for a conventional general lattice structure 10;

FIG. 2 is a reference diagram explaining the properties of metal for microwaves according to plasma frequency;

FIG. 3 is a diagram showing the relationship between transmittance (T) and metal filling fraction (E) for a metal pattern layer 100 having a metamaterial structure according to one embodiment of the present disclosure;

FIG. 4 is a drawing schematically showing a unit structure 120 of the metal pattern layer 100 illustrated in FIG. 3;

FIGS. 5A, 5B, 6A, 6B and 6C are graphs showing the results according to the change in structural parameters for the unit structure 120 of the metal pattern layer 100 shown in FIG. 4;

FIG. 7 is a top view of a color-exhibiting structure 200 for hiding a radar sensor according to an embodiment of the present disclosure;

FIG. 8 is a partial cross-sectional perspective view of the unit structure (A) of FIG. 7;

FIG. 9 is a drawing showing the structure of a unit metamaterial pattern 211;

FIG. 10 is a drawing showing an example of structure color implementation of a color implementation pattern layer 230 to which a single thin-film layer structure is applied;

FIGS. 11A and 11B are drawings showing the difference in the lamination thickness for implementing the structure color of a non-absorbing dielectric (a, Dielectric) and a light-absorbing dielectric (b, Absorbing dielectric);

FIG. 12 is a drawing showing an example of structure color implementation of the color implementation pattern layer 230 to which a multilayer thin-film layer structure is applied;

FIG. 13 is a drawing showing an example of a multilayer thin-film layer formed by alternately laminating one or more dielectric layers and a metal layer;

FIG. 14 includes drawings showing the results of implementing achromatic and black colors using interference-based structure color;

FIG. 15 includes graphs showing the results of investigating changes in microwave transmission spectra according to the structural parameters of a multilayer thin-film structure; and

FIG. 16 is a schematic drawing of a radar apparatus 300 including the color-exhibiting structure 200 functioning as the metamaterial-type transparent heater illustrated in FIG. 7.

### DETAILED DESCRIPTION OF THE DISCLOSURE

It should be understood that the examples and terms used herein are not intended to limit the technology described in this document to a particular embodiment, but rather to encompass various modifications, equivalents, and/or alternatives of the embodiments.

In the following description of the present disclosure, detailed description of known functions and configurations incorporated herein will be omitted when it may make the subject matter of the present disclosure unclear.

In addition, the terms used in the specification are defined in consideration of functions used in the present disclosure, and can be changed according to the intent or conventionally used methods of clients, operators, and users. Accordingly, definitions of the terms should be understood on the basis of the entire description of the present specification.

In description of the drawings, like reference numerals may be used for similar elements.

The singular expressions in the present specification may encompass plural expressions unless clearly specified otherwise in context.

In this specification, expressions such as “A or B” and “at least one of A and/or B” may include all possible combinations of the items listed together.

Expressions such as “first” and “second” may be used to qualify the elements irrespective of order or importance, and are used to distinguish one element from another and do not limit the elements.

It will be understood that when an element (e.g., first) is referred to as being “connected to” or “coupled to” another element (e.g., second), the first element may be directly connected to the second element or may be connected to the second element via an intervening element (e.g., third).

As used herein, “configured to” may be used interchangeably with, for example, “suitable for”, “ability to”, “changed to”, “made to”, “capable of”, or “designed to” in terms of hardware or software.

In some situations, the expression “device configured to” may mean that the device “may do ˜” with other devices or components.

For example, in the sentence “processor configured to perform A, B, and C”, the processor may refer to a general purpose processor (e.g., CPU or application processor) capable of performing corresponding operation by running a dedicated processor (e.g., embedded processor) for performing the corresponding operation, or one or more software programs stored in a memory device.

In addition, the expression “or” means “inclusive or” rather than “exclusive or”.

That is, unless mentioned otherwise or clearly inferred from context, the expression “x uses a or b” means any one of natural inclusive permutations.

Terms, such as “unit” or “module”, etc., should be understood as a unit that processes at least one function or operation and that may be embodied in a hardware manner, a software manner, or a combination of the hardware manner and the software manner.

Hereinafter, the present disclosure is described in more detail with reference to the attached drawings showing examples of the present disclosure.

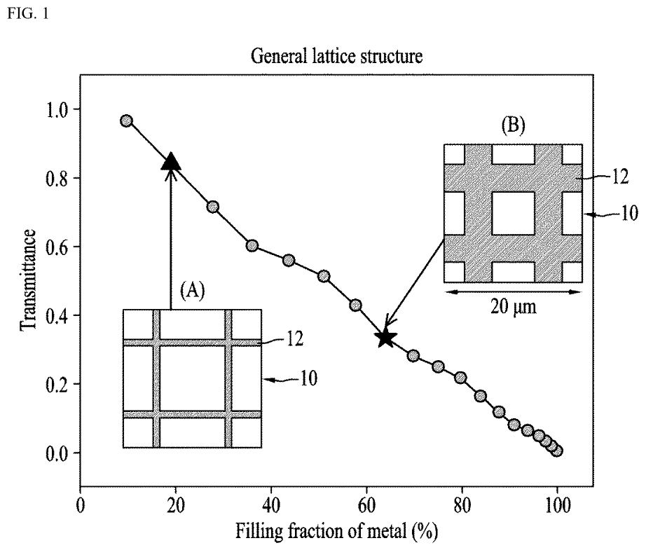

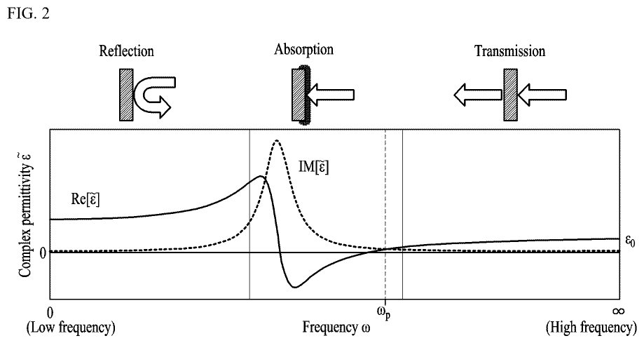

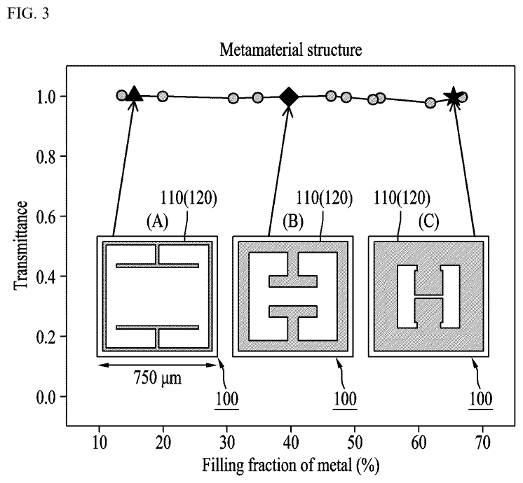

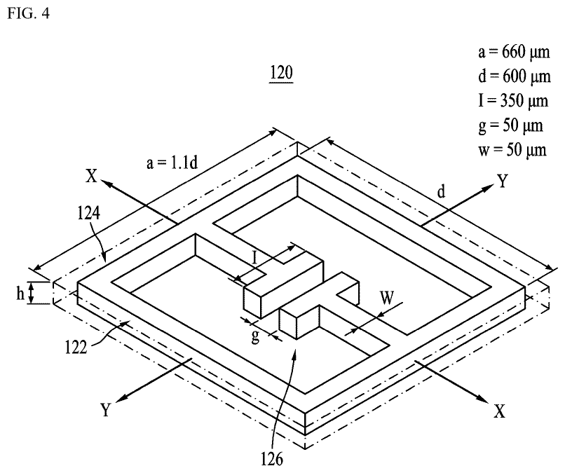

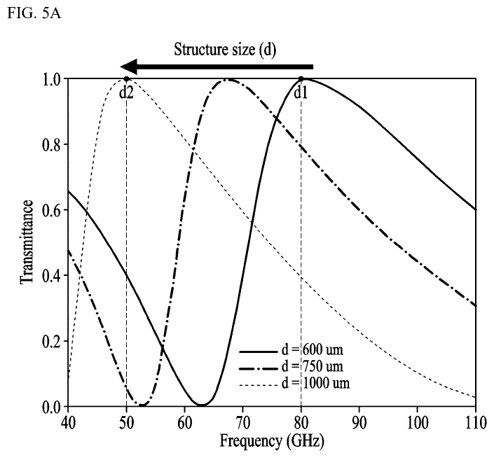

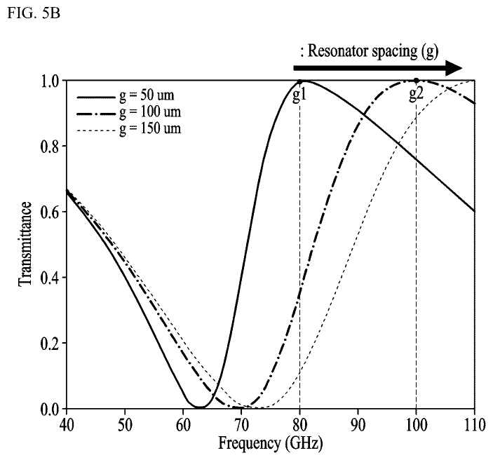

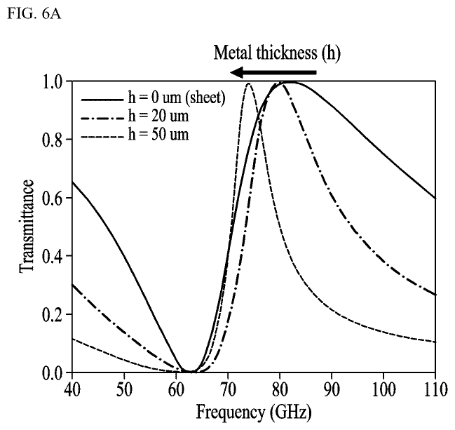

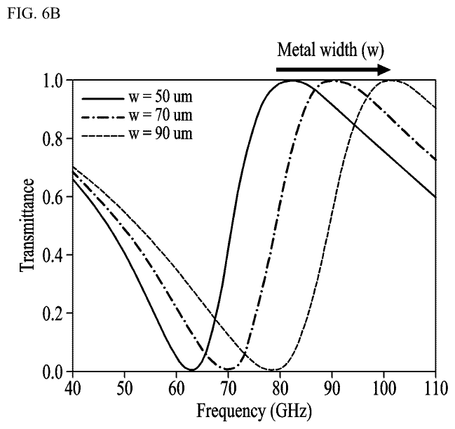

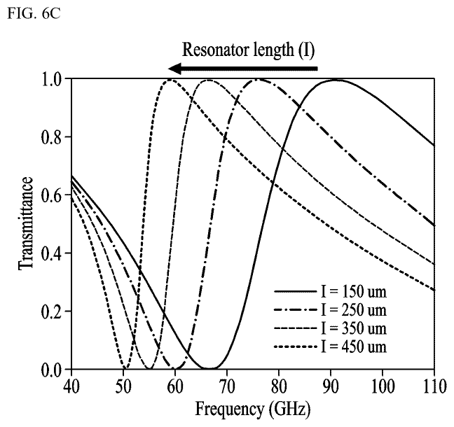

FIG. 1 is a diagram showing the relationship between transmittance (T) and metal filling fraction (E) for a conventional general lattice structure 10, and FIG. 2 is a reference diagram explaining the properties of metal for microwaves according to plasma frequency, FIG. 3 is a diagram showing the relationship between transmittance (T) and metal filling fraction (E) for a metal pattern layer 100 having a metamaterial structure according to one embodiment of the present disclosure, FIG. 4 is a drawing schematically showing a unit structure 120 of the metal pattern layer 100 illustrated in FIG. 3, and FIGS. 5A, 5B, 6A, 6B and 6C are graphs showing the results according to the change in structural parameters for the unit structure 120 of the metal pattern layer 100 shown in FIG. 4.

FIG. 1 shows a graph of the relationship between transmittance (T) and metal filling fraction (E) of the general lattice structure 10.

As shown in FIG. 1, the general lattice structure 10 is used in a conventional electric heater and may be formed as a metal lattice pattern 12 in which metal is arranged in a lattice shape. In the general lattice structure 10, the transmittance (T) of microwaves decreases linearly as metal filling fraction (E) increases, and the transmittance (T) of microwaves increases linearly as metal filling fraction (E) decreases.

Here, the metal filling fraction (E) is the ratio of metal filling per unit area of the general lattice structure 10. Therefore, when the width of the metal lattice pattern 12 increases, the metal filling fraction (E) increases, and when the length of the metal lattice pattern 12 increases, the unit area of the general lattice structure 10 expands, so the metal filling fraction (E) decreases.

That is, the general lattice structure 10 satisfies the relationship between the metal filling fraction (E) and the transmittance (T) of microwaves, as described in Equation 1 below.

$$T = ( 1 - E ) \qquad [ Equation 1 ]$$

For example, in the general lattice structure 10 illustrated in (A) of FIG. 1, the metal filling fraction (E) is 30% and the transmittance (T) of microwaves is 70%. In the general lattice structure 10 illustrated in (B) of FIG. 1, the metal filling fraction (E) is 70% and the transmittance (T) of microwaves is 30%.

As shown in Equation 1 and FIG. 1, the metal filling fraction (E) and transmittance (T) of the general lattice structure 10 are linear, which may be explained by the relationship between metal and plasma frequency as shown in FIG. 2.

FIG. 2 shows the changes in the metal permittivity and the characteristics of electromagnetic wave transmission, absorption, and reflection near the plasma frequency.

As shown in FIG. 2, metals behave as ‘metallic mirrors’ with high reflectivity for electromagnetic waves with frequencies lower than the plasma frequency. Conversely, metals behave as ‘transparent dielectrics’ with high transmittance for electromagnetic waves with frequencies higher than the plasma frequency.

However, since the plasma frequency of typical metals is located in the ultraviolet range, metals exhibit reflective properties for visible light, infrared, and microwaves. Therefore, when the metal lattice pattern 12 of the general lattice structure 10 is formed of a metal material, the metal lattice pattern 12 impedes the passage of microwaves, and thus the transmittance (T) of microwaves necessarily decreases as the metal filling fraction (E) increases.

FIG. 3 illustrates the metal pattern layer 100 according to one embodiment of the present disclosure, and also illustrates a graph of the relationship between transmittance (T) and metal filling fraction (E) for the metal pattern layer 100 of the present embodiment.

As shown in FIG. 3, the metal pattern layer 100 according to one embodiment of the present disclosure is formed as a metal pattern 110 that allows the transmittance (T) of microwaves to reach the transmittance of air in a specific frequency band of microwaves. The metal pattern 110 may be provided in an electrically interconnected form to perform a heating function.

The metal pattern 110 may be formed of at least one metal material from among copper (Cu), silver (Ag), gold (Au), aluminum (Al), a liquid metal (e.g., eutectic GaIN), and an alloy including any one of copper (Cu), silver (Ag), gold (Au), and aluminum (Al). At this time, the metal pattern 110 may be patterned into a pre-designed pattern through any one of a semiconductor lithography process and a printing process.

For example, the metal pattern 110 may be formed of any one metal material of copper (Cu), silver (Ag), gold (Au), aluminum (Al), and a liquid metal (e.g., eutectic GaIN), or may be formed of an alloy including any one of copper (Cu), silver (Ag), gold (Au), and aluminum (Al), or may be formed of two or more metal materials selected from the alloy, copper (Cu), silver (Ag), gold (Au), aluminum (Al), and a liquid metal (e.g., eutectic GaIN).

As described above, the metal pattern 110 may have conductive properties because the metal pattern 110 is formed of a metal material with excellent electrical conductivity. Accordingly, the metal pattern 110 is formed as an electrically interconnected form, so that the metal pattern 110 may perform a heating function like a heating wire when electricity is applied. For reference, when the metal pattern 110 is formed using a liquid metal, there is an advantage in that even when some parts are damaged or opened, the metal pattern 110 is restored to the original state thereof after a certain period of time by reconnecting with each other due to the characteristics of the liquid metal.

In addition, in the metal pattern 110 of the present embodiment, the relationship between the metal filling ratio (E) in a specific frequency band of microwaves and the transmittance (T) of the microwaves may satisfy the relationship between the metal filling fraction (E) and the transmittance (T) of the microwaves described in Equation 2 below. Here, the metal filling fraction (E) is the ratio of metal filled per unit area of the metal pattern 110.

$$T > ( 1 - E ) \qquad [ Equation 2 ]$$

For example, in the metal pattern layer 100 shown in (A) of FIG. 3, the metal filling fraction (E) of the metal pattern 110 is 15% and the transmittance (T) of the microwaves is close to 100%. In the metal pattern layer 100 shown in (B) of FIG. 3, the metal filling fraction (E) of the metal pattern 110 is 40% and the transmittance (T) of the microwaves is close to 100%. In the metal pattern layer 100 shown in (C) of FIG. 3, the metal filling fraction (E) of the metal pattern 110 is 65% and the transmittance (T) of the microwaves is close to 100%. Accordingly, in the metal pattern layer 100 illustrated in FIG. 3, microwaves completely transmit through the metal pattern layer 100 because the transmittance (T) of the microwaves remains close to 100% even when the metal filling fraction (E) increases or decreases in a specific frequency band of the microwaves.

Hereinafter, in the present embodiment, the specific frequency band of microwaves where the transmittance (T) of microwaves is close to 100% may be set to 70 to 110 GHz including the W band or 4.4 to 52.6 GHz, which is a 5G/6G communication band, and this is defined as a ‘resonance frequency band’. In the resonance frequency band as described above, the transmittance (T) of microwaves may satisfy the relationship T>(1−E) regardless of the size of the metal filling fraction (E). However, it is desirable to set the specific frequency band of microwaves appropriately by considering the microwave frequency band of the radar apparatus 300 or mobile communication device described later, and it is desirable to set the transmittance (T) of microwaves as close to 100% as possible.

As described above, microwaves in the resonance frequency band recognize the metal pattern 110 of the metal pattern layer 100 as a metamaterial whose transmittance (T) of microwaves approaches 100%, so that almost no loss occurs due to reflection and absorption during the passage of microwaves.

In general, a metamaterial is a material that implements a desired permittivity, such as one that does not exist in nature, in a specific frequency range through the structuring or mixing of materials with a well-known permittivity. The design method of metamaterials is divided into ‘resonant metamaterials’ that artificially excite electric or magnetic dipoles using metals, and ‘nonresonant metamaterials’ that mix and arrange two or more types of materials with different permittivity on a subwavelength scale.

Here, in the case of resonant metamaterials (also called meta-atoms), the design of artificial material dispersion is possible when the optical loss of metal due to free electrons may be neglected. Accordingly, resonant metamaterials may operate effectively in the microwave frequency range where metals may be considered as perfect conductors.

That is, the metal pattern layer 100 of the present embodiment is provided as a pattern that makes the metal pattern 110 a metamaterial, and thus may have microwave transmission characteristics that are completely different from the metal lattice pattern 12 of the general lattice structure 10 described above. However, the microwave transmission characteristics of the metal pattern layer 100 of the present embodiment may be implemented only in the resonance frequency band.

FIGS. 4 to 6C show the transmittance change according to the structural change of the first unit structure 120 and the first unit structure 120 of the metal pattern layer 100 according to one embodiment of the present disclosure.

Referring to FIGS. 4 to 6C, the metal pattern 110 formed on the metal pattern layer 100 of the present embodiment may be provided as a structure in which a plurality of the first unit structures 120 are continuously connected. One first unit structure 120 may be placed per unit area of the preset metal pattern 110. The metal pattern 110 of the metal pattern layer 100 may be arranged in a form in which the first unit structure 120 is continuously connected to another first unit structure 120 arranged adjacent to the first unit structure 120. At this time, unit metal patterns may be formed in each of the first unit structures 120. The unit metal patterns of the first unit structures 120 as described above may be gathered to form the metal pattern 110 of the metal pattern layer 100.

It is desirable to design the pattern of the first unit structure 120 so that the transmittance (T) of the microwaves approaches 100% according to the metal filling fraction (E) in the resonance frequency band of the microwaves. In addition, in this embodiment, it is possible to secure close to perfect transmission characteristics of microwaves through optimization work on the pattern of the first unit structure 120 even when the metal filling fraction (E) of the first unit structure 120 changes from 10% to 70%.

For example, the unit metal pattern of the first unit structure 120 according to the present embodiment may include first straight patterns 122, second straight patterns 124, and electric dipoles 126.

Each of the first straight patterns 122 may be formed on the horizontal side of the first unit structure 120 so as to be parallel to the first direction (X-X), which is the horizontal direction of the first unit structure 120.

Each of the second straight patterns 124 may be formed on the vertical side of the first unit structure 120 so as to be parallel to the second direction (Y-Y), which is the vertical direction of the first unit structure 120. Hereinafter, in this embodiment, it is described that the first direction (X-X) and the second direction (Y-Y) are set in the horizontal and vertical directions of the first unit structure 120 so as to be orthogonal to each other at the center point of the first unit structure 120. The both ends of the second straight patterns 124 as described above may be connected to the both ends of the first straight patterns 122, respectively. Accordingly, the first straight patterns 122 and the second straight patterns 124 may be formed as a square pattern design along the edge portion of the first unit structure 120.

The electric dipoles 126 are arranged spaced apart from each other inside the first straight patterns 122 and the second straight patterns 124, and by controlling the degree of separation, the function of modulating the frequency at which the transmittance of the microwaves is maximum may be performed. Hereinafter, in this embodiment, the electric dipoles 126 are described as a structure that extends from the second straight patterns 124 toward the center point of the first unit structure 120, but are arranged spaced apart from the center point of the first unit structure 120.

As shown in FIGS. 4 to 6C, in the metal pattern layer 100 of this embodiment, the resonance frequency band may be changed in a desired direction by selectively changing the structural parameters of the first unit structure 120.

The structural parameters of the first unit structure 120 may include at least one of the size (d) of the second straight patterns 124, the metal thickness (h) of the first and second straight patterns 122 and 124 and the electric dipoles 126, the metal width (w) of the first and second straight patterns 122 and 124 and the electric dipoles 126, the separation distance (g) of the electric dipoles 126, and the size (l) of the electric dipoles 126. Hereinafter, in this embodiment, it is explained that the metal thickness (h) of the first and second straight patterns 122 and 124 and the electric dipoles 126 are all formed to be the same, and the metal width (w) of the first and second straight patterns 122 and 124 and the electric dipoles 126 are all formed to be the same.

The graphs measuring the change in transmittance (T) of microwaves when changing the structural parameters of the first unit structure 120 as described above are shown in FIGS. 5 and 6.

As shown in FIG. 5A, the size (d) of the first and second straight patterns 122 and 124, described as “structure size (d)”, is increasing in the direction of the arrow. As the size (d) of the first and second straight patterns 122 and 124 increases, the total area of the first unit structure 120 may expand and the metal filling fraction (E) may relatively decrease. At this time, it can be confirmed that the resonance frequency band changes from d1 to d2 as the size (d) of the first and second straight patterns 122 and 124 increases.

As shown in FIG. 5B, the separation distance (g) of the electric dipoles 126, described as “resonator spacing (g)”, is increasing in the direction of the arrow. As the separation distance (g) of the electric dipoles 126 increases, the metal filling fraction (E) may decrease. At this time, it can be confirmed that the resonance frequency band changes from g1 to g2 as the separation distance (g) of the electric dipoles 126 increases.

As shown in FIG. 6A, the metal thickness (h) of the first and second straight patterns 122 and 124 and the electric dipoles 126, which are described as “metal thickness (h)”, is increasing in the direction of the arrow. At this time, it can be confirmed that the resonance frequency band changes in a decreasing direction as the metal thickness (h) of the first and second straight patterns 122 and 124 and the electric dipoles 126 increases.

As shown in FIG. 6B, the metal width (w) of the first and second straight patterns 122 and 124 and the electric dipoles 126, described as “metal width (w)”, is increasing in the direction of the arrow. When the metal width (w) of the first and second straight patterns 122 and 124 and the electric dipoles 126 increases, the metal filling fraction (E) may increase. At this time, it can be confirmed that the resonance frequency band changes in the increasing direction as the metal width (w) of the first and second straight patterns 122 and 124 and the electric dipoles 126 increases.

As shown in FIG. 6C, the size (l) of the electric dipoles 126, described as “resonator length (l)”, is increasing in the direction of the arrow. When the size (l) of the electric dipoles 126 increases, the metal filling fraction (E) may increase. At this time, it can be confirmed that the resonance frequency band changes in the decreasing direction as the size (l) of the electric dipoles 126 increases.

As described above, in the metal pattern layer 100 of this embodiment, the resonance frequency band exhibits a characteristic of gradual transition as the structural parameters of the first unit structure 120 are selectively increased or decreased. For example, the metal width (w) of the first and second straight patterns 122 and 124 and the electric dipoles 126 and the separation distance (g) of the electric dipoles 126 are proportional to the resonance frequency band, but the size (d) of the first and second straight patterns 122 and 124, the metal thickness (h) of the first and second straight patterns 122 and 124 and the electric dipoles 126, and the size (l) of the electric dipoles 126 are inversely proportional to the resonance frequency band. Accordingly, by appropriately selecting the metal width (w) and metal thickness (h) of the first and second straight patterns 122 and 124 and the electric dipoles 126, the size (l) and separation distance (g) of the electric dipoles 126, and the size (d) of the first and second straight patterns 122 and 124, the transmittance (T) of microwaves may approach 100% even when the metal filling fraction (E) is high. In particular, the separation distance (g) of the electric dipoles 126 significantly induces a shift in the resonance frequency band while barely affecting the metal filling fraction (E), which may be useful when changing the resonance frequency band to a desired frequency band.

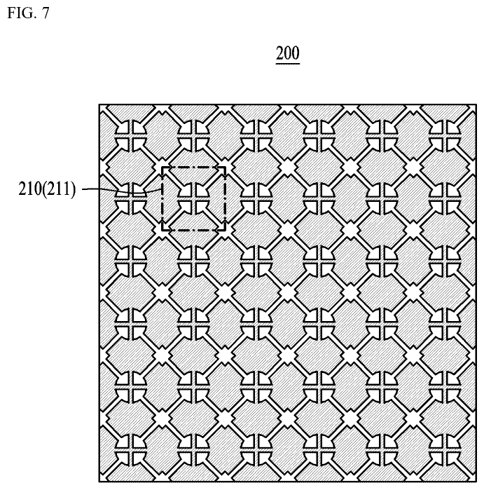

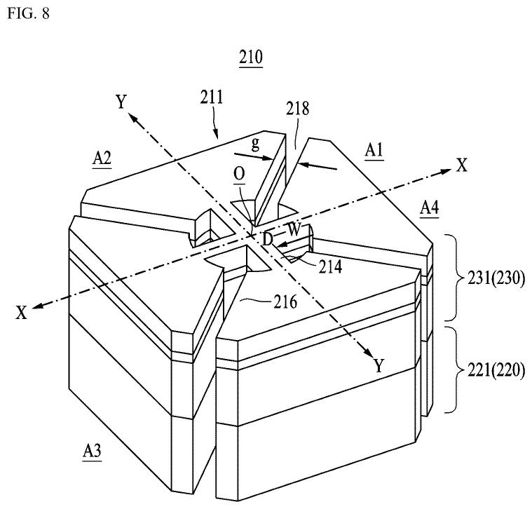

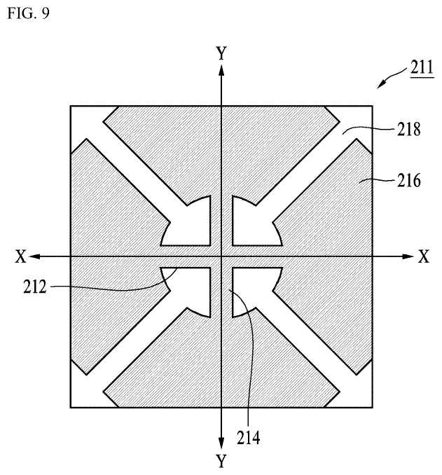

FIG. 7 is a top view of the color-exhibiting structure 200 for hiding a radar sensor (hereinafter, referred to as ‘the color-exhibiting structure 200’) according to an embodiment of the present disclosure, FIG. 8 is a partial cross-sectional perspective view of the unit structure (A) of FIG. 7, and FIG. 9 is a drawing showing the structure of the unit metamaterial pattern 211.

As shown in FIGS. 7 and 8, the color-exhibiting structure 200 may be formed as a metamaterial structure in which the unit metamaterial structures 210 having the unit metamaterial pattern 211 are repeatedly arranged in a lattice pattern.

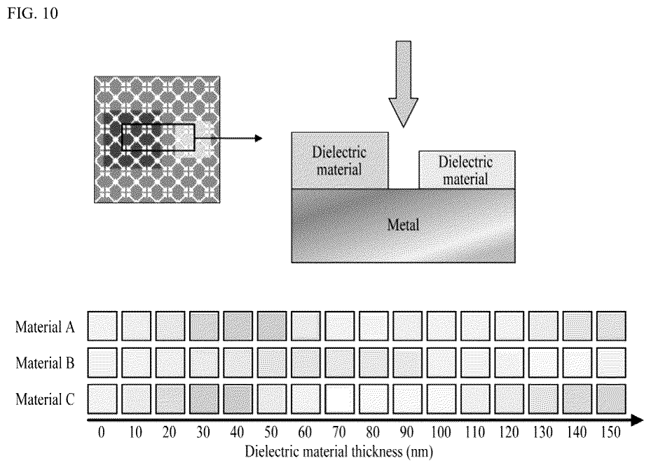

As shown in FIG. 9, the unit metamaterial pattern 211 may include a first linear pattern 212, a second linear pattern 214, an external pattern 216, and a pattern gap 118 (Added explanation in FIG. 10B).

The first linear pattern 212 may be formed long in the first direction (X-X) in the unit area of the unit metamaterial pattern 211. Hereinafter, in the present embodiment, the first linear pattern 212 may be formed as a straight line pattern along the horizontal direction so as to pass through the center point (O) of the unit area of the unit metamaterial pattern 211.

The second linear pattern 216 may be formed long in the second direction (Y-Y) in the unit area of the unit metamaterial pattern 211 so as to intersect the first linear pattern 212. Hereinafter, in the present embodiment, the second linear pattern 216 may be formed as a straight line pattern along the vertical direction so as to pass through the center point (O) of the unit area of the unit metamaterial pattern 211. Accordingly, the first linear pattern 212 and the second linear pattern 216 may form a cross pattern within the unit area of the unit metamaterial pattern 211.

The external pattern 216 may be formed in a circular shape centered on the intersection (O) of the first linear pattern 212 and the second linear pattern 216. The external pattern 216 may be formed to be electrically interconnected to the first linear pattern 212 and the second linear pattern 216. Hereinafter, in the present embodiment, it is described that the horizontal and vertical widths of the external pattern 216 are formed to be the same as the lengths of the first linear pattern 212 and the second linear pattern 216.

Here, the external pattern 216 may be provided with a pattern gap 218 to perform the function of the electric dipoles 126 of the first unit structure 120 of FIG. 4. The pattern gap 218 as described above may be formed in a structure in which a certain portion of the external pattern 216 is opened. As shown in FIG. 8, when the unit area of the unit metamaterial pattern 211 is divided into the quadrant areas A1, A2, A3, and A4, at least one pattern gap 218 may be placed in each of the quadrant areas A1, A2, A3, and A4. Hereinafter, in the present embodiment, it is described that a single pattern gap 218 is placed in each of the quadrant areas A1, A2, A3, and A4.

In addition, the first linear pattern 212, the second linear pattern 216, and the external pattern 216 may be formed to be symmetrical with respect to the center point (O) of the unit area of the unit metamaterial pattern 211, respectively. Accordingly, the first linear pattern 212, the second linear pattern 216, and the external pattern 216 may prevent polarization dependence on microwaves through the symmetrical structure.

The color-exhibiting structure 200 may be formed as a metamaterial structure including the metal pattern layer 220, whose structural parameters are designed to be controlled so that microwaves may be transmitted, and the color implementation pattern layer 230, which is laminated on top of the metal pattern layer 230, whose structural parameters are controlled so that a desired color is implemented.

The unit metamaterial structure 210 may include the unit metal pattern layer 221 having the unit metamaterial pattern 211 formed by controlling structural parameters to be transparent to microwaves, and a unit color implementation pattern layer 231 having the unit metamaterial pattern 211 and laminated on top of the unit metal pattern layer 221.

The unit metal pattern layers 221 forming the unit metamaterial structure 210 may be electrically interconnected to form the metal pattern layer 220 that generates heat.

The unit metamaterial pattern 211 may be arranged one by one per unit area. The metamaterial structure 200 may be formed as a structure in which a plurality of unit metamaterial structures 210 are connected in the first direction (X-X) and the second direction (Y-Y).

When the metamaterial structure 200 is applied as a transparent heater, the unit metal pattern layer 221 forming the unit metamaterial structure 210 may be electrically interconnected to form the metal pattern layer 220 that performs heat generation.

In contrast, when the metamaterial structure 200 is applied to a radar of a 5G/6G mobile communication terminal, the unit metal pattern layers 221 forming the unit metamaterial structure 210 may be arranged in an electrically open state to form the metal pattern layer 220. In contrast, when the metamaterial structure 200 is applied to a laser of a 5G/6G mobile communication terminal and a heater function is required, the unit metal pattern layer 221 forming the unit metamaterial structure 210 may be electrically interconnected to form the metal pattern layer 220 that generates heat.

In the color-exhibiting structure 200 of this embodiment, the specific frequency band of the microwaves may be varied by selectively changing the structural parameters of the unit metamaterial structure 210.

The structural parameters may include one or more of the size, length, thickness, width, and separation distance of each component having the structural symmetry of the unit metamaterial pattern 211 constituting the unit metamaterial structure 210.

Specifically, by selectively changing the structural parameters of the first linear pattern 212, the second linear pattern 216, and the external pattern 216 in the unit metamaterial pattern 211, the resonance frequency band of microwaves may be easily varied.

In this case, the length, thickness, width, separation distance, and the like of the first linear pattern 212, the second linear pattern 214, the external pattern 216, and the pattern gap 118 may be structural parameters.

For example, the structural parameters may include at least one of the length (a1) of the first linear pattern 212, the thickness (h1) of the first linear pattern 212, the width (w1) of the first linear pattern 212, the length (a2) of the second linear pattern 216, the thickness (h2) and width (w2) of the second linear pattern 216, the width and height (D) of the external pattern 216, the thickness (h3) of the external pattern 216, the width (w3) of the external pattern 216, the separation distance (g) of the pattern gap 218, and the number of the pattern gap 218.

Hereinafter, in the present embodiment, the length (a=a1=a2=a3), width (w=w1=w2=w3), and thickness (h=h1=h2=h3) of the first linear pattern 212, the second linear pattern 216, and the external pattern 216 are all the same, and the width and height (D) of the external pattern 216 are set to be the same as the length (a=D) of the first linear pattern 212 and the second linear pattern 216.

Accordingly, in the unit metamaterial pattern 211 of the present embodiment, the structural parameters may be appropriately changed to set the resonance frequency band to a desired band, and the structural parameters may be appropriately adjusted to set the desired resonance frequency band.

The unit color implementation pattern layer 230 may be composed of a single thin-film layer of dielectric in which one or more thin films are laminated to implement color by interference with visible light, or a multilayer thin-film layer in which dielectric and metal layers are alternately laminated.

The single thin film layer may be either a dielectric layer or a light-absorbing dielectric layer.

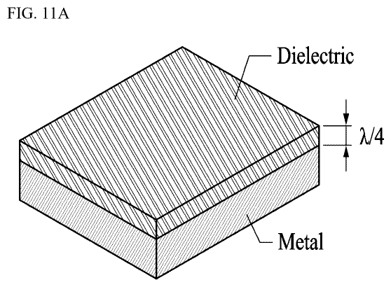

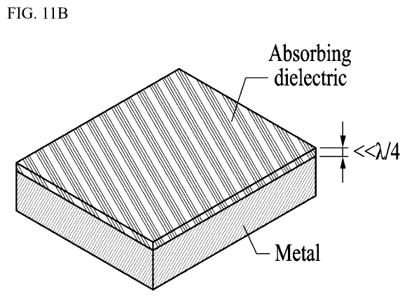

FIG. 10 is a drawing showing an example of structure color implementation of a color implementation pattern layer 230 to which a single thin-film layer structure is applied, and FIGS. 11A and 11B are drawings showing the difference in the lamination thickness for implementing the structure color of a non-absorbing dielectric (a, Dielectric) and a light-absorbing dielectric (b, Absorbing dielectric).

As shown in FIG. 10, when only one different dielectric (material 1, material 2, material 3) is applied and laminated as a single thin film layer, various structure colors may be implemented depending on the laminated thickness.

The dielectric forming the dielectric layer may include a lead-free transparent dielectric with ZrO₂, Al₂O₃, HfO₂, TiO₂, Y₂O₃, SiO₂, Si₃N₄, P₂O₅, and V₂O₅ as main components and dielectrics such as B₂O₃—SiO₂—Al₂O₃—BaO—Li₂O₃-based dielectrics, Bi₂O₃—B₂O₃—BaO-based dielectrics, BaO—B₂O₃—ZnO-based dielectrics, and Bi₂O₃—B₂O₃—ZnO-based dielectrics.

The light-absorbing dielectric is a dielectric that absorbs visible light and includes materials such as Si and Ge.

The wavelength of the structure color to be implemented may be A.

When implementing structure color through the unit color implementation pattern layer 231 formed of a single thin film layer of a non-light-absorbing dielectric, as shown in FIG. 11A, the single dielectric layer laminated on top of the metal pattern layer 220 for optical interference is laminated to have a thickness of 24.

As shown in FIG. 10, the non-light-absorbing dielectric may be laminated with a thickness of more than 0 nm and 150 nm or less to implement a desired structure color.

As shown in FIG. 10, in the visible light range, different structure colors appeared even when the thickness of the thin film was the same depending on materials with different permittivity.

In contrast, when the dielectric is a light-absorbing dielectric, as in FIG. 11B, the single dielectric layer laminated on top of the metal pattern layer 220 may be laminated to have a thickness of λ/4 or less depending on the light absorption rate of the dielectric.

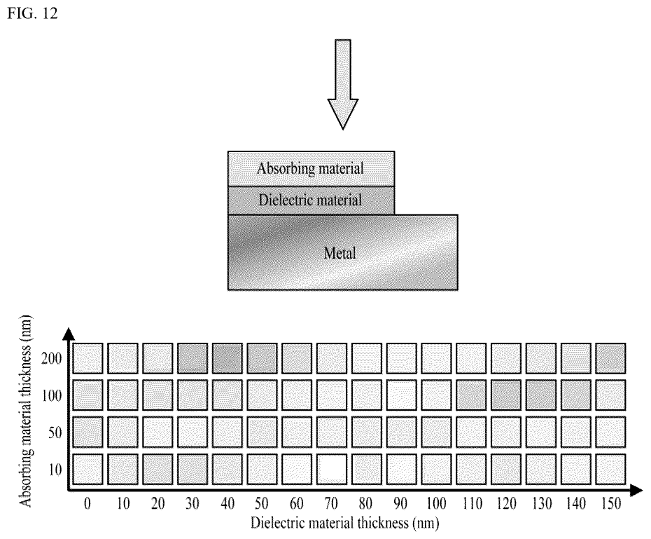

FIG. 12 is a drawing showing an example of structure color implementation of the color implementation pattern layer 230 to which a multilayer thin-film layer structure is applied.

When applying a multilayer thin-film layer, a design with a wider range of colors is possible than when applying a single thin-film layer. Accordingly, the range of structure colors that may be realized in the visible light range may be expanded by appropriately selecting a deposition material and each thin film thickness. Since the thickness of the thin film does not satisfy the interference condition in the microwave transmission range, 100% microwave transmission characteristics could be implemented even when the color implementation pattern layer 230 was applied.

As shown in FIGS. 11A and 12, when applying a light-absorbing dielectric to the color implementation pattern layer 230, it was possible to control the structure color by applying a thinner film than when applying a non-light-absorbing dielectric. In this case, the structural parameters are defined by the type and thickness of the material used in the multilayer thin film.

As shown in FIG. 12, the light-absorbing dielectric may be laminated with a thickness of greater than 0 nm and 200 nm or less to implement a desired structure color.

As shown in FIG. 12, the color implementation pattern layer 230 of the multilayer thin-film layer structure may be configured by alternately laminating one or more non-light-absorbing dielectric layers (Dielectric) and light-absorbing dielectric layers (Absorbing material).

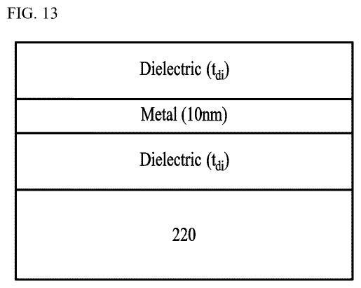

FIG. 13 is a drawing showing an example of a multilayer thin-film layer formed by alternately laminating one or more dielectric layers and a metal layer.

As shown in FIG. 13, the multilayer thin-film layer may be formed by alternately laminating one or more dielectric layers and metal layers.

When the color implementation pattern layer 230 laminated on top of the metal pattern layer 220 is laminated as a multilayer thin-film layer that does not include a light-absorbing dielectric layer, the total thickness of the color implementation pattern layer 230 may be designed to have a thickness of N₄ when the wavelength of the desired structure color is λ.

When the color implementation pattern layer 230 laminated on top of the metal pattern layer 220 is laminated as a multilayer thin-film layer including a light-absorbing dielectric layer, the total thickness of the color implementation pattern layer 230 may be designed to have a thickness of λ/4 or less when the wavelength of the desired structure color is λ.

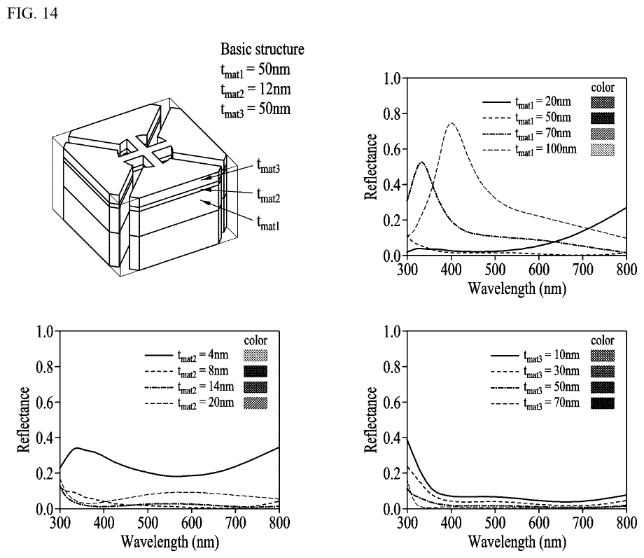

FIG. 14 includes drawings showing the results of implementing achromatic and black colors using interference-based structure color.

In FIG. 14, tₘₐₜ₁ and tₘₐₜ₃ are the thicknesses of dielectric layers with different permittivity, and tₘₐₜ₃ is the thickness of a metal layer.

As shown in FIGS. 13 and 14, when the color implementation pattern layer 230 is alternately laminated with a dielectric layer and a metal layer with varying thickness, various dark structure colors are implemented. It was possible to design a structure so that destructive interference occurs in the visible light range by controlling the thickness of each layer. Accordingly, by adjusting the structural parameters of the color implementation pattern layer 230 to cause destructive interference of all visible light, a black structural color could be implemented without using a separate paint.

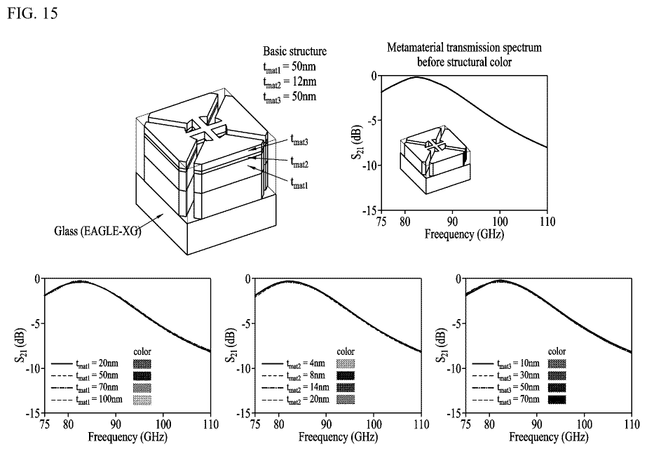

FIG. 15 includes graphs showing the results of investigating changes in microwave transmission spectra according to the structural parameters of a multilayer thin-film structure.

For the color-exhibiting structure 200 of the present disclosure, it is essential that the transmittance is minimal at a particular microwave frequency.

The microwave transmission spectra of the color-exhibiting structure 200 were compared before and after the introduction of structural parameters for implementing structure color as described with reference to FIGS. 10 to 14.

As shown in FIG. 15, it was confirmed that the microwave transmission spectra were maintained regardless of whether structural parameters were introduced or whether the structural parameters were adjusted.

Specifically, it was confirmed that the microwave transmission spectra transmitted through the color-exhibiting structure 200 before the introduction of structure color were the same as when the dielectric and metal layers were alternately deposited on the metal pattern layer 220, which is a metal-based metamaterial.

When the thickness of each layer was set as a structural parameter, it was also confirmed that the increase or decrease of each structural parameter had little effect on the resonant frequency at which the microwave transmittance became 100%.

Therefore, by introducing the color implementation pattern layer 230 having an interference-based thin film structure, it was possible to implement useful structure colors by color control without affecting the functional elements of the color-exhibiting structure 200 as a microwave transparent heater.

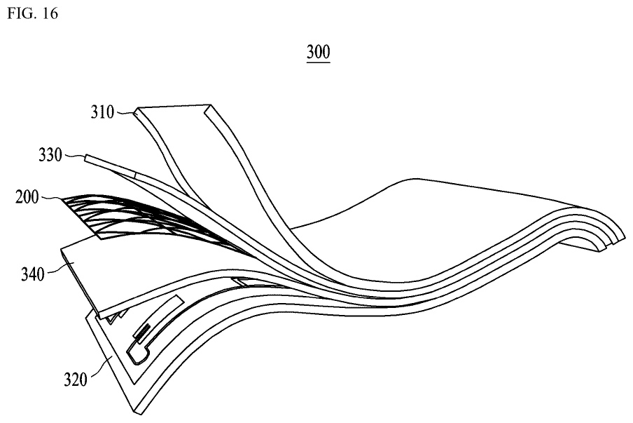

FIG. 16 is a schematic drawing of a radar apparatus 300 including the color-exhibiting structure 200 functioning as the metamaterial-type transparent heater illustrated in FIG. 7.

Referring to FIG. 16, the radar apparatus 300 according to the present embodiment may include the color-exhibiting structure 200 functioning as a metamaterial-type transparent heater, a protective cover 310, a radar sensor module 320, an insulating packaging member 330, and a substrate member 340.

Here, the metamaterial-type color-exhibiting structure 200 is formed in the same structure as the metamaterial-type color-exhibiting structure 200 illustrated in FIGS. 7 to 9, so a detailed description thereof is omitted.

In addition, the protective cover 310 is a transparent protective material that protects the metamaterial-type transparent heater 200 and may be placed on the front side of the metamaterial-type transparent heater 200. The protective cover 310 as described above may generate smoke due to frost, freezing, and the like under harsh environmental conditions. However, the smoke of the protective cover 310 may be stably removed by the heat generated from the metamaterial-type transparent heater 200.

In addition, the radar sensor module 320 may detect obstacles or people in front of the protective cover 310 by using microwaves passing through the protective cover 310 and the metamaterial-type color-exhibiting structure 200. The radar sensor module 320 may be placed at the rear of the metamaterial-type color-exhibiting structure 200.

In addition, the insulating packaging member 330 may be arranged between the metamaterial-type color-exhibiting structure 200 and the protective cover 310. The insulating packaging member 330 is formed of an insulating film of a transparent material and may be closely attached to the metamaterial-type color-exhibiting structure 200 and the protective cover 310.

In addition, the substrate member 340 may be arranged between the metamaterial-type color-exhibiting structure 200 and the radar sensor module 320. The substrate member 340 is formed of a composite film of a transparent material, and is preferably formed of an insulating material so that the radar sensor module 320 is not affected by heat generated from the metamaterial-type color-exhibiting structure 200.

The color-exhibiting structure 200, the protective cover 310, the radar sensor module 320, the insulating packaging member 330, and the substrate member 340 are all formed of a flexible and elastic material and may be arranged in a curved shape according to the installation space and design conditions of the radar apparatus 300. For reference, in the radar apparatus 300 according to the present embodiment, the resonance frequency band of microwaves may vary depending on the permittivity values of the insulating packaging member 330 and the substrate member 340. Accordingly, when designing the radar apparatus 300, it is desirable to sufficiently consider the change in resonance frequency band according to the permittivity value of the insulating packaging member 330 and the substrate member 340.

When the color-exhibiting structure 200 described above is applied as a transparent heater of a radar sensor, the unit metal pattern layers 221 forming the metal pattern layer 220 are electrically connected and an electrical terminal (not shown) is mounted on one side thereof. Accordingly, electricity is supplied through the electrical terminal. Accordingly, electricity may be supplied to the entire unit metal pattern layer 221 to generate heat. Thus, a transparent heater and structure color expression function for protecting a radar sensor may be performed.

In contrast, the color-exhibiting structure 200 may be applied to protect radar sensors for ISAC applied to 5G/6G mobile communication terminals. In this case, the unit metal pattern layers 221 forming the metal pattern layer 220 may be manufactured to remain open to each other. Accordingly, the color-exhibiting structure 200 may function to express only a structure color.

The metal pattern layer 220 and the color implementation pattern layer 230 of the color-exhibiting structure 200 according to the embodiment of the present disclosure described above may be patterned through any one of a semiconductor lithography process or a printing process including 3D printing.

The present disclosure can provide a transparent heater for radar sensors that simultaneously achieves high transmittance and high conductivity.

The present disclosure provides a metamaterial structure that can be applied to the exterior of mobile communication terminals such as 5G/6G mobile communication terminals to implement colors for aesthetic purposes and provide color expression functions while allowing microwaves to be transmitted.

The present disclosure can secure original technology for a microwave transparent heating film material for protecting a radar or lidar sensor, which facilitates the implementation of desired structure colors.

The effects of the present disclosure are not limited to the above-described effects, and effects not mentioned herein will be clearly understood by those skilled in the art from the present specification and the accompanying drawings.

Although the present disclosure has been described with reference to limited embodiments and drawings, it should be understood by those skilled in the art that various changes and modifications may be made therein. For example, the described techniques may be performed in a different order than the described methods, and/or components of the described systems, structures, devices, circuits, etc., may be combined in a manner that is different from the described method, or appropriate results may be achieved even if replaced by other components or equivalents.

Therefore, other embodiments, other examples, and equivalents to the claims are within the scope of the following claims.

### DESCRIPTION OF SYMBOLS

310: GENERAL LATTICE STRUCTURE
100: METAL PATTERN LAYER
110: METAL PATTERN
200: COLOR-EXHIBITING STRUCTURE
210: UNIT METAMATERIAL STRUCTURE
211: UNIT METAMATERIAL PATTERN
212: FIRST LINEAR PATTERN
214: SECOND LINEAR PATTERN
216: EXTERNAL PATTERN
218: PATTERN GAP
220: METAL PATTERN LAYER
221: UNIT METAL PATTERN LAYER
230: COLOR IMPLEMENTATION PATTERN LAYER
231: UNIT COLOR IMPLEMENTATION PATTERN LAYER

What is claimed is:

1. A color-exhibiting structure, wherein the color-exhibiting structure is a metamaterial structure comprising a metal pattern layer in which metal patterns having a unit metamaterial pattern formed to satisfying a relationship of T>(1−E) when a transmittance (T) of microwaves is a metal filling fraction (E) in a specific frequency band of the microwaves are periodically arranged; and
a color implementation pattern layer having the same unit metamaterial pattern as the metal pattern and laminated with one or more dielectric layers or metal layers on top of the metal pattern layer.

2. The color-exhibiting structure according to claim 1, wherein the color implementation pattern layer is formed as a single thin film layer laminated with a non-light-absorbing single dielectric thin film whose thickness is set to implement a structure color by interference between incident visible light and visible light reflected from the metal pattern layer.

3. The color-exhibiting structure according to claim 1, wherein the color implementation pattern layer is formed as a single thin film layer laminated with a light-absorbing single dielectric thin film whose thickness is set to implement a structure color by interference between incident visible light and visible light reflected from the metal pattern layer.

4. The color-exhibiting structure according to claim 1, wherein the color implementation pattern layer is formed as a multilayer thin-film layer formed by alternately laminating, one or more times, a non-light-absorbing single dielectric thin film whose thickness is set to implement a structure color by interference between incident visible light and visible light reflected from the metal pattern layer; and a light-absorbing single dielectric thin film whose thickness is set to implement a structure color by interference between incident visible light and visible light reflected from the metal pattern layer.

5. The color-exhibiting structure according to claim 1, wherein the color implementation pattern layer is formed as a multilayer thin-film layer comprising a non-light-absorbing dielectric thin-film layer whose thickness is set to implement a structure color by interference between incident visible light and visible light reflected from the metal pattern layer; and
a metal layer whose thickness is set to implement a structure color by interference between incident visible light and visible light reflected from the metal pattern layer,
wherein the thin-film layer and the metal layer are alternately laminated one or more times.

6. The color-exhibiting structure according to claim 2, wherein the color implementation pattern layer is designed to have a thickness of 24 when a wavelength of the structure color to be implemented is 2.

7. The color-exhibiting structure according to claim 1, wherein the color implementation pattern layer comprises a light-absorbing dielectric thin-film layer whose thickness is set to implement a structure color by interference between incident visible light and visible light reflected from the metal pattern layer; and
a metal layer whose thickness is set to implement a structure color by interference between incident visible light and visible light reflected from the metal pattern layer,
wherein the thin-film layer and the metal layer are alternately laminated one or more times.

8. The color-exhibiting structure according to claim 3, wherein the color implementation pattern layer is designed to have a thickness of λ/4 or less when a wavelength of the structure color to be implemented is λ.

9. The color-exhibiting structure according to claim 1, wherein the unit metamaterial pattern has structural symmetry with respect to two mutually orthogonal directions with respect to a center point of a unit area of the metal pattern so that the polarization dependence on microwaves does not occur.

10. The color-exhibiting structure according to claim 1, wherein the unit metamaterial pattern comprises a first linear pattern formed long in a first direction in a unit area of the unit metamaterial pattern;
a second linear pattern formed long in a second direction in the unit area of the unit metamaterial pattern so as to intersect with the first linear pattern; and
an external pattern electrically interconnected to the first linear pattern and the second linear pattern from an outside of the first linear pattern and the second linear pattern, and arranged radially, centered on an intersection of the first linear pattern and the second linear pattern.

11. The color-exhibiting structure according to claim 10, wherein the external pattern further comprises a pattern gap formed by opening a portion of the external pattern to perform an electric dipole function.

12. The color-exhibiting structure according to claim 11, wherein, when a unit area of the metal pattern is divided into quadrant areas, at least one pattern gap is placed in each of the quadrant areas.

13. The color-exhibiting structure according to claim 1, wherein the specific frequency band of the microwaves is varied by selectively changing structural parameters of the unit metamaterial structure, and
the structural parameters comprise one or more of size, length, thickness, width, and separation distance of each component having a structural symmetry of a unit metamaterial pattern constituting the unit metamaterial structure.

14. The color-exhibiting structure according to claim 1, wherein the specific frequency band of the microwaves is set to 70 to 110 GHz comprising a W band or 4.4 to 52.6 GHz, which is a 5G/6G communication frequency band.

15. The color-exhibiting structure according to claim 1, wherein the metal pattern layer is formed such that a relationship between a metal filling fraction (E) per unit area of the metal pattern and a transmittance (T) of the microwaves satisfies a relationship of T>(1−E) for both orthogonal polarizations in the specific frequency band of the microwaves.

16. The color-exhibiting structure according to claim 1, wherein a metal forming the metal pattern layer comprises one or more of copper, silver, gold, aluminum, a liquid metal, and an alloy comprising any one of copper, silver, gold, and aluminum.

17. The color-exhibiting structure according to claim 1, wherein the color-exhibiting structure has a pattern structure in which a plurality of unit metamaterial structures are sequentially connected, wherein the unit metamaterial structures comprise laminated unit metal pattern layers having the unit metamaterial pattern and a unit color implementation pattern layer laminated on top of the unit metal pattern layers.

18. The color-exhibiting structure according to claim 17, wherein the unit metal pattern layers are electrically interconnected with each other, and
the color-exhibiting structure is applied as a transparent heater for shielding a radar sensor or lidar sensor by further comprising an electric terminal having one end that is connected to the metal pattern layer and the other end to which external electricity is applied for heating the metal pattern layer.

19. The color-exhibiting structure according to claim 1, wherein the color-exhibiting structure has a pattern structure in which a plurality of unit metamaterial structures, wherein the unit metamaterial structures comprise laminated unit metal pattern layers are arranged to be electrically open to each other.

20. A radar apparatus, comprising:
the color-exhibiting structure of a metamaterial structure according to claim 1;
a protective cover made of transparent material placed on a front of the color-exhibiting structure; and
a radar sensor module positioned at a rear of the color-exhibiting structure to detect obstacles in front of the protective cover through microwaves passing through the protective cover and the color-exhibiting structure.

21. The radar apparatus according to claim 20, further comprising an insulating packaging member made of transparent material placed between the color-exhibiting structure and the protective cover; and
a substrate member made of transparent material placed between the color-exhibiting structure and the radar sensor module.
